(19) United States
(12) Patent Application Publication
(10) Pub. No.: US 2007/0230100 A1
(43) Pub. Date: Oct. 4, 2007

(54) Flexible floating electronic components

(75) Inventors: Howard J. Locker, Cary, NC (US); Daryl Cromer, Cary, NC (US); James Hunt, Chapel Hill, NC (US); Tin-Lup Wong, Chapel Hill, NC (US)

Correspondence Address: FERENCE & ASSOCIATES LLC, 409 BROAD STREET, PITTSBURGH, PA, 15143, US

(73) Assignee: Lenovo (Singapore) Pte. Ltd, Singapore (SG)

(21) Appl. No.: 11/394,656

(22) Filed: Mar. 31, 2006

(51) Int. Cl. G06F 1/16

(52) U.S. Cl. 361/683; 361/687

(57) ABSTRACT

A method and apparatus for absorbing shocks and stresses associated with the movement of electrical components housed in electronic devices and especially in mobile electronic devices, and more particularly the use of gel as a means for floating electrical components within an electronic device housing, wherein portions of the gel are capable of electrically connecting critical electronic components within the fixed set of parameters thereby absorbing shocks and reducing stresses and allowing for flexible electrical interconnections to be established along isolated conductive gel pathways.

### FIELD OF THE INVENTION

The present invention relates generally to a method and apparatus for absorbing shocks and stresses associated with the movement of electrical components housed in electronic devices and especially in mobile electronic devices, and more particularly relates to use of gel as a means for floating electrical components within an electronic device housing, wherein portions of the gel are capable of electrically interconnecting critical electronic components within the fixed set of parameters thereby absorbing shocks and reducing stresses and allowing for flexible electrical interconnections to be established along isolated conductive gel pathways.

### BACKGROUND OF THE INVENTION

Electronic devices are comprised of a multitude of electronic components many of which are electrically interconnected to one another and to other electronics devices. A printed circuit board (“PCB”), for example a motherboard, is one of the most important of these electrical components. Various other electrical components are normally connected to the printed circuit board allowing a wide range of functions to be performed. For example, today's motherboards can be connected to other circuit boards, memory cards, and hard drives, as well as to other peripheral devices such as a mouse, keyboard, printer, and monitor. Conventionally, the connection of the latter peripheral components results from the mating of electrical connectors, e.g. plugs and sockets. For example, a typical motherboard may have connectors such as a mouse connector; a keyboard connector; a serial port; a parallel port; a VGA connector; USB ports; a LAN connector; ATA/IDE connectors; and speaker connectors. These connectors are often housed directly on the circuit board using techniques known in the art, for example wire bonding. However, such connectors can also be mounted to the electronic device's housing structure independently of one another and independent of the other electronic components. Similarly, PCBs can be mounted to one another or independently of one another. While components and connectors are said to be housed independently of one another it should be appreciated that an electrical connection via means known in the art may still connect these elements through electronic interconnections, thus, enabling the floating independent movement of the electronic components while maintaining an electrical interconnection. These electrical components and connectors are usually enclosed in protective housings in a rigid or semi-rigid fashion.

As technology develops the size of electronic devices continues to decrease while the electronic package density, i.e., the number of components contained within an electronic device and electrically interconnected to other components, is steadily increasing. These developments have allowed ever more powerful electronic devices to be manufactured in smaller packages. The smaller packages or housings, along with other advances, has also enabled the shift from essentially immobile electronic devices to fully mobile devices to occur.

While these advances continue there are factors impeding the development of very complex mobile devices as well. Namely, the inability to adequately protect the electrical components in a mobile device, including the electronic interconnections, from damage as a result of the electronic device's movement and vibrations. As people move about with their mobile electronic devices the devices are subjected to a variety of stresses not normally subjected to stationary electronics, for example the shock resulting from a mobile device being dropped. While the dropping of a device may be one of the more extreme examples, there are many less extreme stresses that over time can be just as harmful if not more so. For example, the normal vibrations associated with typical movement contributes to electronic component and interconnection failures as can the vibrations associated with hard disk drive spinning. Other events which may lead to device failures include plug-in and plug-out events, i.e., the physical action of making a connection between components using a plug/socket connector arrangement. Where connectors are wire bonded directly to a PCBs, for example, a plug-in and out event can be extremely stressful to the PCBs and also to the PCB-PCB connector electrical interconnection.

In larger mobile devices like laptop computers the strains and stresses associated with mobility take their heaviest tolls. Of course, laptops also suffer from the plug-in and out stress as discussed above but they also suffer from countless other stresses. For example, laptops are dropped; they are transported in less than ideal conditions, for example in a bag full of books; they are carried by one end, thereby placing an enormous strain on the PCBs and other components housed within; they are operated during various types of vehicular transportation in which they are subjected to vibrations and jarring; they contain spinning components such a hard disk drives (HDD), CD/DVD-ROMs, and fans that can each cause vibrational wear to the electronic components and interconnections within the device; and other countless stresses and strains. Thus it is no wonder why these and other mobile devices tend to regularly fail.

Regarding electrical components, in general, such components have been mounted within an electronic device's housing or package without a means for decreasing the transference of the stresses or vibrations applied to a device's housing or package from housing to the components. Thus when a device housing or package suffers a shock or vibration the same is transferred to all of the device's electronic components, including the PCBs and electrical interconnectors (e.g. the connections between Plug/Socket connectors, such as a VGA, to a PCB, such as a motherboard).

Some attempts have been made to minimize shock and vibration on circuits; however, the state of the art has yet to overcome these problems. One general approach appears to focus upon floating circuits within a housing using spring mechanisms to achieve independent float. These approaches have met with limited success and mobile devices, especially larger devices such as laptop computers, continue to regularly fail as a result of normal stresses. Moreover, such approaches have failed to address the stresses caused to the electrical interconnections themselves. Thus by floating electrical components independently of one another more harm can actually be caused due to the additional stresses and strains placed on the electronic interconnections that are forced to absorb the suspension vibrations caused by floating circuits via mechanical means. Typical these electrical interconnections are in the form of wire bonds, cable harnesses, or ribbon connectors. These means for interconnection provide some flexibility but are difficult to assemble in smaller devices, such as mobile devices, and can cause interference between electrical components if they are not positioned to avoid the other electrical components. The difficulty to adequately position such interconnections should be easily appreciated in mobile devices having high package densities and smaller package or housing sizes. Therefore, while their appears to be a general approach to protecting individual components, the means for achieving such protection to date is far from perfected and, moreover, has failed to address a device's overall failure rate, because other components have been placed under increased strains causing their failure and thus ultimately the device's failure.

A need has therefore been recognized in connection with providing an effective means for protecting electronic components from shock and vibrational stresses while also protecting electronic interconnections from the damaging effects of vibration, shock, the normal day-to-day movements of mobile devices, and plug-in and out events. Thus there is a need to allow PCBs and other electronic components to float independently of one another within a device's housing or package and to be flexibly electrically interconnected in an efficient and space conserving manner.

### SUMMARY OF THE INVENTION

There is broadly contemplated, in accordance with at least one presently preferred embodiment of the present invention, a method and apparatus for floating electrical components within an electronic housing, e.g. a laptop computer, wherein gel can be used as the means for floating the electrical components independently of one another. Furthermore, isolated conductive pathways may be formed on the inner surfaces of the electronic device's housing thereby providing pathways between the electrical components. Various types of electrically conductive gels can be positioned within the isolated electrical pathways thereby allowing electrical conduction between the electrical components, which may include connectors as well as other components such as printed circuit boards (e.g. motherboard) and other components known to those in the art. Furthermore, it should be fully understood that the use of such isolated electrically conductive gel pathway electrical interconnections allows for the interconnections to be highly flexible, thereby reducing stress, strain, and damage in an electronic device having independently floating electrical components interconnected to one another and to connectors as well.

A first embodiment of the present invention is an apparatus for floating the electronic component(s) of an electronic device, said apparatus comprising: an electronic device housing having a bottom inner surface, top inner surface, and attached inner side surfaces; and a layer of gel in contact with at least one of the electronic device surfaces of the electronic device housing for floating an electronic component within said electronic device housing. Said fist embodiment could further comprise an electronic component in contact with said gel and floatably maintained within said electronic device housing without directly contacting the inner surfaces of the electronic device housing.

In a another embodiment of the present invention is an apparatus for floating the electronic component(s) of an electronic device, said apparatus comprising: a laptop computer comprising a housing having a bottom inner surface, top inner surface, and attached inner side surfaces; a layer of gel in contact with at least one of the housing surfaces; a plurality of electronic components floatably maintained by said gel within the housing so as not to contact said inner surfaces of said housing; an isolated conductive pathway formed on at least one inner surface of the housing; and an electrically conductive gel for electrically interconnecting said plurality of electronic components deposited within the bounds of said isolated conductive pathway, thereby electrically interconnecting said electronic components.

In another embodiment of the present invention is a method for floating electrical components of an electronic device, the method comprising the steps of: forming an electronic device housing having a bottom inner surface, top inner surface, and attached inner side surfaces; and depositing a layer of gel in contact with at least one of the electronic device surfaces of the electronic device housing for floating an electronic component within said electronic device housing. It should be appreciated said method might further comprise, an electronic component in contact with said gel so that said electronic component is floatably maintained within said electronic device housing without directly contacting the inner surfaces of the electronic device housing.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 schematically illustrates electronic components housed within a protective space electrically interconnected to one another in accordance with at least one embodiment of the present invention, wherein an gel independently floats the components while electrically interconnecting said components.

FIG. 2 schematically illustrates a cross-sectional view of the presently preferred embodiment.

### DESCRIPTION OF THE PREFERRED EMBODIMENTS

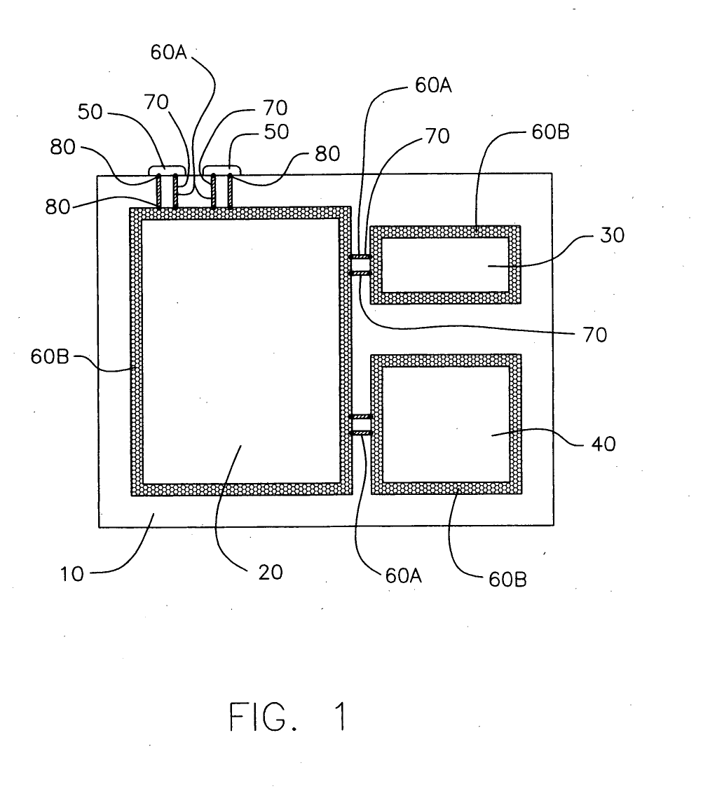

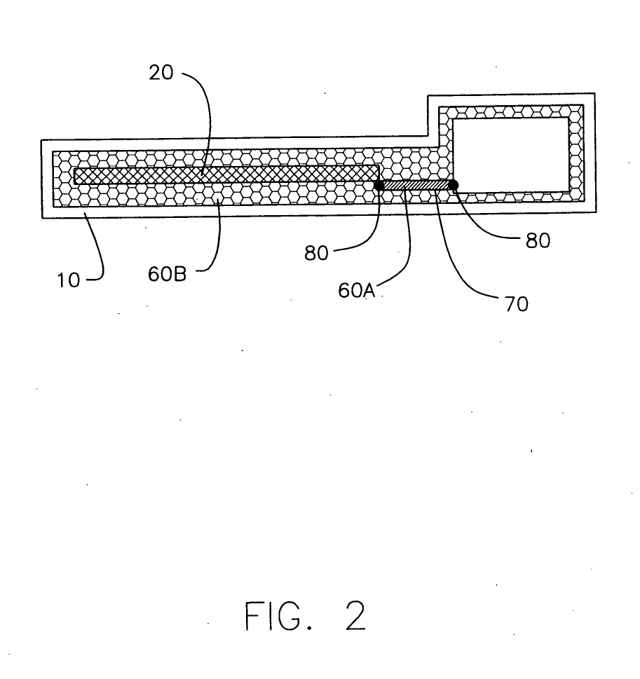

Referring to the drawings, in FIG. 1 there is shown features of the presently preferred embodiment of the invention. FIG. 1 provides an example of how the basic elements of the present device are assembled and used. In FIG. 1 and FIG. 2 there is shown a top-down view and a cross-sectional view, respectively, of a mobile electronic device, such as a laptop computer. It should be understood that for ease of understanding the electronic device housing 10 as shown in FIGS. 1 and 2 does not illustrate the physical elements appearing outside of the housing, such as the laptop's computer screen and keyboard, but rather the inner housing is represented. Contained within the device housing 10, as shown in FIG. 1, is: a motherboard 20; a PCB graphics card 30; a hard disk drive 40; and two USB ports 50. It should be understood, many arrangements are possible and the present invention is in no way limited to any one particular configuration. It should also be noted, other electronic components are generally contained within a laptop computer but have not been represented in the figures as they are known to those skilled in the art and unnecessary for an understanding of the present embodiment.

As shown in FIGS. 1 and 2, a combination of electrically conductive gel 60A and non-conductive gel 60B is used to float the motherboard 20, the graphics card 30, and the HDD 40 in an independent state within the housing 10. As is known in the art, Gel elastomers are highly viscoelastic polymer gels that have excellent shock absorption, thermal, and damping characteristics. They are available in a variety of material types and grades and can be molded into a fabricated shape to enclose the motherboard and interconnectors. The right gel elastomers for an application can be determined by analyzing the mechanical, electrical, and thermal properties of the mobile device. Mechanical properties include tensile strength, tensile modulus, and elongation. Resistivity, dielectric strength, and dielectric constant are important electrical properties. Thermal properties include use temperature, deflection temperature, thermal conductivity, and coefficient of thermal expansion. Use temperature is the range of temperatures to which materials can be exposed without degradation of structural or other required end-use properties. Thermal conductivity is the linear heat transfer per unit area through a material for a given applied temperature gradient. Electrically conductive products provide low resistivity and are used to prevent electrostatic discharge (ESD), electromagnetic interference (EMI), and radio frequency interference (RFI) and to provide electrical interconnections.

As indicated above non-conductive gels can be used to isolate signals. Using the combination of conductive and non-conductive gels allows for the total enclosure of the electronic components and electrical interconnections of a mobile device.

Furthermore, as shown in FIG. 1, the motherboard 20 is electronically interconnected to both USB ports 50, the graphics card 30, and the HDD 40. The electrical interconnections are achieved by the electrical conduction along isolated gel pathways 70. Each of the isolated gel pathways 70 is electrically isolated from one another and uses electrically conductive gel 60A. It should be appreciated that various means for isolating the electrically conductive gel 60A can be used. For example, as described above a conductive gel pathway may be achieved by surrounding electrically conductive gel with non-conductive gel Also one skilled in the art can appreciate that it would also be possible to manufacture the housing 10 such that housing barriers isolate not only the gel pathways 70, but also the electronic components and connectors as well.

As further illustrated in FIG. 1, the conductive gel pathways 70 are electrically connected to the various electronic components and connectors at an electrically conductive interface 80. As is known to one skilled in the art, various electrically conductive materials could be used as the interfaces 80 with the isolated gel pathways 70, including solder ball bumps.

Therefore, with reference to FIGS. 1 and 2 there is shown a mobile electronic device wherein various electrical components are floated in both electrically conductive and non-conductive gel and flexibly electrically interconnected so as to allow independent movement and flexible interconnection between electronic components and connectors along isolated electrically conducting gel pathways.

Although the preferred embodiment of the present invention has been described herein with reference to the accompanying drawings, it is to be understood that the invention is not limited to that precise embodiment, and that various other changes and modifications may be affected therein by one skilled in the art without departing from the scope or spirit of the invention.

What is claimed is:

1. An apparatus comprising:
an electronic device housing having a bottom inner surface, top inner surface, and attached inner side surfaces; and
a layer of gel in contact with at least one of the electronic device surfaces of the electronic device housing for floating an electronic component within said electronic device housing.

2. The apparatus according to claim 1, further comprising:
an electronic component in contact with said gel and floatably maintained within said electronic device housing without directly contacting the inner surfaces of the electronic device housing.

3. The apparatus according to claim 2, wherein said electronic component is a motherboard.

4. The apparatus according to claim 2, further comprising:
a plurality of electronic components floatably maintained within said electronic device housing so as not to contact said inner surfaces of said device housing.

5. The apparatus according to claim 4, further comprising:
an electrically conductive gel for electrically interconnecting said plurality of electronic components.

6. The apparatus according to claim 4, further comprising:
an isolated conductive pathway formed on at least one inner surface of the electronic device housing; and
an electrically conductive gel for electrically interconnecting said plurality of electronic components deposited within the bounds of said isolated conductive pathway, thereby electrically interconnecting said electronic components.

7. The apparatus according to claim 4, wherein:
said plurality of electronic components include electrically conductive interfaces for electrically interconnecting said components.

8. The apparatus according to claim 2, wherein:
one of said electronic device housing surfaces has an opening for retaining a connector within said opening; and further comprising:
a connector for connecting said electronic device to a peripheral electronic device.

9. The apparatus according to claim 8, further comprising:
an isolated conductive pathway formed on at least one inner surface of the electronic device between an electronic component and said connector; and
an electrically conductive gel for electrically interconnecting said electronic component and said connector deposited within the bounds of said isolated conductive pathway.

10. An apparatus comprising:
a laptop computer comprising a housing having a bottom inner surface, top inner surface, and attached inner side surfaces;
a layer of gel in contact with at least one of the housing surfaces;
a plurality of electronic components floatably maintained by said gel within the housing so as not to contact said inner surfaces of said housing;
an isolated conductive pathway formed on at least one inner surface of the housing; and
an electrically conductive gel for electrically interconnecting said plurality of electronic components deposited within the bounds of said isolated conductive pathway, thereby electrically interconnecting said electronic components.

11. The apparatus according to claim 10, wherein said plurality of electronic components comprises a motherboard.

12. A method comprising the steps of:
forming an electronic device housing having a bottom inner surface, top inner surface, and attached inner side surfaces; and
depositing a layer of gel in contact with at least one of the electronic device surfaces of the electronic device housing for floating an electronic component within said electronic device housing.

13. The method according to claim 12, further comprising the steps:
positioning an electronic component in contact with said gel so that said electronic component is floatably maintained within said electronic device housing without directly contacting the inner surfaces of the electronic device housing.

14. The method according to claim 13, wherein said electronic component is a motherboard.

15. The method according to claim 13, further comprising the steps:
positioning a plurality of electronic components so that they are floatably maintained within said electronic device housing so as not to contact said inner surfaces of said device housing.

16. The method according to claim 15, further comprising the steps:
depositing an electrically conductive gel for electrically interconnecting said plurality of electronic components.

17. The method according to claim 15, further comprising the steps:
forming an isolated conductive pathway on at least one inner surface of the electronic device housing; and
depositing an electrically conductive gel for electrically interconnecting said plurality of electronic components within the bounds of said isolated conductive pathway, thereby electrically interconnecting said electronic components.

18. The method according to claim 15, wherein:
said plurality of electronic components include electrically conductive interfaces for electrically interconnecting said components.

19. The method according to claim 13, wherein:
an opening is formed in one of the surfaces of said electronic device housing for retaining a connector within said opening; and further comprising the step of:
retaining a connector within said opening for connecting said electronic device to a peripheral electronic device.

20. The method according to claim 19, further comprising the steps:
forming an isolated conductive pathway on at least one inner surface of the electronic device between an electronic component and said connector; and
electrically interconnecting said electronic component and said connector by depositing an electrically conductive gel within the bounds of said isolated conductive pathway.
